(19) United States
(12) Patent Application Publication
(10) Pub. No.: US 2024/0205262 A1
(43) Pub. Date: Jun. 20, 2024

(54) Preventing delivery of service attacks on a communication network

(71) Applicant: TELEFONAKTIEBOLAGET LM ERICSSON (PUBL), STOCKHOLM (SE)

(72) Inventors: Shah Nauman Nizami, Göteborg (SE); Raya Altarabulsi, Hisings Backa (SE); Magnus Almgren, Göteborg (SE); Amel Mujkanovic, Västra Frölunda (SE)

(21) Appl. No.: 18/287,175

(22) PCT Filed: Apr. 14, 2021
(86) PCT No.: PCT/EP2021/059666

§ 371 Date: Oct. 16, 2023

(51) Int. Cl. H04L 9/40

(52) U.S. Cl. CPC H04L 63/1458

(57) ABSTRACT

The present disclosure relates to a control unit arrangement (6, 6′, 6″) that is adapted to acquire instructions relating to one or more certain predefined scheduling communication patterns for communication between a wireless communication node (2) and a served user terminal (3a, 3b, 3c) comprised in a wireless communication system (1), and to determine if the user terminal (3a, 3b, 3c) is scheduled according to any one of the predefined scheduling communication patterns for a number of times that exceeds a predetermined number of times. If that is the case, the control unit arrangement (6, 6′, 6″) is adapted to report the user terminal (3a, 3b, 3c) to a communication traffic handling function (4, 5) comprised in the wireless communication system (1).

### TECHNICAL FIELD

The present disclosure relates to preventing delivery of service attacks on a communication network, in particular in baseband processing.

### BACKGROUND

The fifth generation of wireless networks (5G) is adapted to, and also expected to, provide high-rate data streams for a multitude of users at all times time by means of downlink (DL) and uplink (UL) data flows.

For a DL data flow, DL data is transmitted to user equipment (UE) from a base station (gNB) that expects feedback in the form of a positive acknowledgement (ACK) or a negative acknowledgment (NACK) response from the UE. If the UE was able to successfully decode the DL data, it sends an ACK response. However, if the UE was not able to decode the DL data it sends a NACK instead. If a NACK is received at gNB side, the gNB performs a retransmission of the DL data. There is a predetermined maximum number of retransmissions that can be performed for a DL packet before a hybrid automatic repeat request (HARQ) failure can be declared. When this maximum number has been reached, it is considered as a radio link failure (RLF) and the UE is detached.

If a UE does not send anything at all instead of sending a NACK, then the gNB decodes it as a DTX (discontinuous transmission). A DTX also triggers a retransmission.

Information regarding the maximum number of retransmission information can be acquired by an attacker, for example by analysis on DL data redundancy version or a new data indicator. Once the attacker has this information, the attacker can control one or more UE:s to send ACK/NACK response to the gNB so as to maximize the wastage of radio resources without being declared as a HARQ failure. In particular, the attacker can control the UE:s to send NACK responses that almost reach the maximum number, and then send an ACK response. By requiring several unnecessary re-retransmissions, network recourses are wasted on the expense of other network users.

For an UL data flow, a medium access control (MAC) control element called buffer status report (BSR) is used for additional data requirements. When a UE is connected to a gNB and there is a need of UL radio resources to send UL data to gNB, the UE requests additional resources by sending a BSR. The BSR informs the gNB of how much data that is in UE's buffers and the gNB schedules UL radio resources accordingly.

An attacker can control a UE to communicate a BSR that has a higher value than the actual BSR, and the higher value of the BSR, the more network resources such as time in time slot and bandwidth are allocated to the UE, as well as a plurality of re-transmissions. The UE is then allocated unnecessary network recourse on the expense of other network users.

If the attacker uses a so-called botnet of UE:s, the attacker can be successful in performing a massive delivery of service (DOS) attack on a communication network's resources.

It is therefore desired to provide means and methods for preventing an attacker to waste network recourses, and to perform a DOS attack.

### SUMMARY

It is an object of the present disclosure to provide means and methods for preventing an attacker to waste network recourses, and to perform a DOS attack.

This object is obtained by means of control unit arrangement that is adapted to acquire instructions relating to one or more certain predefined scheduling communication patterns for communication between a wireless communication node and a served user terminal comprised in a wireless communication system. The control unit arrangement is further adapted to determine if the user terminal is scheduled according to any one of the predefined scheduling communication patterns for a number of times that exceeds a predetermined number of times. If that is the case, the control unit arrangement is adapted to report the user terminal to a communication traffic handling function comprised in the wireless communication system.

This means that user terminals that display a suspicious behavior in regard of a denial of service (DOS) attacks can be reported such that disconnection of these user terminals from further operation in the communication system is enabled. This also enables better system performance since users which are not attackers but generally performing badly can be reported such that these users can be disconnected from the communication system for short durations.

According to some aspects, a predefined scheduling communication pattern comprises that the number of re-transmissions in downlink (DL) has reached or falls below a predefined first maximum number of re-transmissions by a predefined number of times for a certain transmission. According to some aspects, the predefined number of times is 1 or 2.

This way, an attacker that gets access to the predefined maximum number of re-transmissions, can be prevented from balancing on the edge of the maximum number of re-transmissions, avoiding an increased load on the communication system. In particular, in the case of an attacker using a large number of user terminals that are automatically controlled, a so called botnet of user terminals, an attacker could be successful in performing a DOS attack on the DL radio resources if the attacker is not prevented.

According to some aspects, the predefined scheduling communication pattern comprises that a channel quality indication, provided by the user terminal, exceeds a certain threshold value.

This means that it can be more accurately determined that a user terminal displays a suspicious behavior in regard of a DOS attack, if the user terminal seems to need all, all almost all, available re-transmissions time after time while the channel seem to be of good quality, the probability that the user terminal displays a suspicious behavior in regard of a DOS attack increases.

According to some aspects, the number of re-transmissions is determined by means of a hybrid automatic repeat request (HARQ) response received from the user terminal.

This means that misuse of HARQ in the wireless communication system is prevented.

According to some aspects, a predefined scheduling communication pattern comprises that the number of re-transmissions in uplink (UL) has reached or falls below a predefined second maximum number of re-transmissions by a predefined number of times for a certain transmission. According to some aspects, the predefined number of times is 1 or 2.

This way, an attacker that gets access to the predefined maximum number of re-transmissions, can be prevented from balancing on the edge of the maximum number of re-transmissions, avoiding an increased load on the communication system. In particular, in the case of an attacker using a large number of user terminals that are automatically controlled, a so called botnet of user terminals, an attacker could be successful in performing a DOS attack on the UL radio resources if the attacker is not prevented.

According to some aspects, the predefined scheduling communication pattern comprises that a signal to interference plus noise ratio (SINR) value calculated for said certain transmission exceeds a certain SINR threshold value.

According to some aspects, the predefined scheduling communication pattern comprises that for each re-transmission, there is a user terminal data buffer status report (BSR) from the user terminal that exceeds a certain BSR threshold value. The control unit arrangement according to claim 9, wherein the BSR indicates that the required network resources exceeds the BSR threshold value.

This means that it can be more accurately determined that a user terminal displays a suspicious behavior in regard of a DOS attack, if the user terminal seems to need all, all almost all, available re-transmissions time after time while the channel and the user terminal buffer status seem to be good, the probability that the user terminal displays a suspicious behavior in regard of a DOS attack increases.

According to some aspects, the number of re-transmissions is determined by means of a hybrid automatic repeat request (HARQ) response decoded at the node.

This means that misuse of HARQ in the wireless communication system is prevented.

According to some aspects, if the control unit arrangement has determined that the served user terminal is not scheduled according to any one of the predefined scheduling communication patterns, the control unit arrangement is adapted to lower the number of times that the served user terminal has been determined to be scheduled according to any one of the predefined scheduling communication patterns by a certain amount. According to some aspects, the number is lowered a certain amount that corresponds to the number being lowered to zero.

This way, a user terminal that is behaving in a suspect manner only temporally, is not reported to the communication traffic handling function

Alternatively, according to some further aspects, the number is lowered a certain amount that differs from time to time that the control unit arrangement is adapted to determine in a random manner.

This prevents an attacker to foresee the amount the number is lowered.

By making sure that the BSR and HARQ is not misused in a system, denial of service attacks can be prevented, which attacks otherwise can be difficult to detect and find defense against.

Furthermore, the present disclosure can participate in achieving better system performance by removing the very bad performing real users from the system for short durations.

This object is also obtained by means of a wireless communication node, a wireless communication system and methods in a wireless communication system that are associated with the above advantages.

### BRIEF DESCRIPTION OF THE DRAWINGS

The present disclosure will now be described more in detail with reference to the appended drawings, where:

FIG. 1 schematically shows a view of a wireless communication system;

FIG. 2 schematically shows a block chart of components in the wireless communication system;

FIG. 3 shows a flowchart for a downlink procedure;

FIG. 4 shows a flowchart for an uplink procedure; and

FIG. 5 shows a flowchart for methods according to embodiments.

### DETAILED DESCRIPTION

Aspects of the present disclosure will now be described more fully hereinafter with reference to the accompanying drawings. The different devices, systems, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

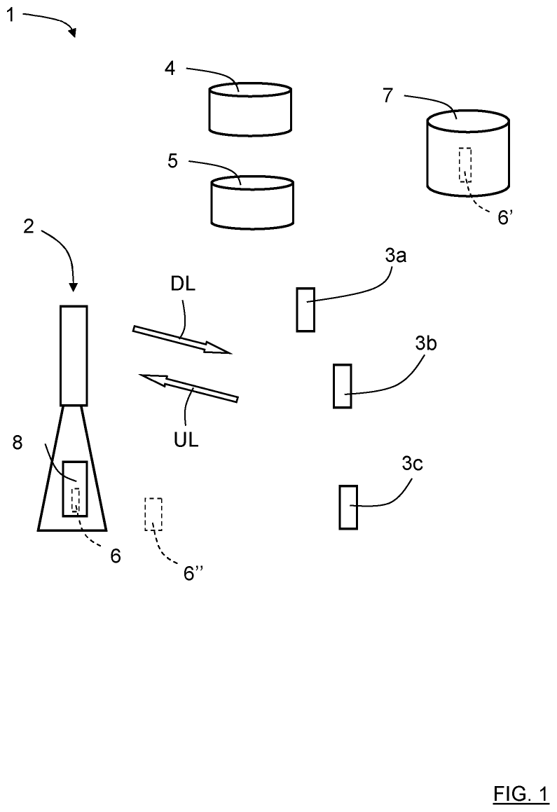

As shown in FIG. 1, there is a wireless communication system 1 that comprises a wireless communication node 2, a core network 4 and a radio resource controller (RRC) 5 that is adapted to set up communication between served user terminals 3a, 3b, 3c and the core network 4. According to some aspects, the RRC 5 comprises a communication traffic handling function. According to some further aspects, the wireless communication system 1 comprises different system layers, where the node 2 comprises a baseband layer, and where the core network 4 and the RRC 5 constitute higher layers. It is to be noted that the RRC 5 can be comprised in the node 2 as well.

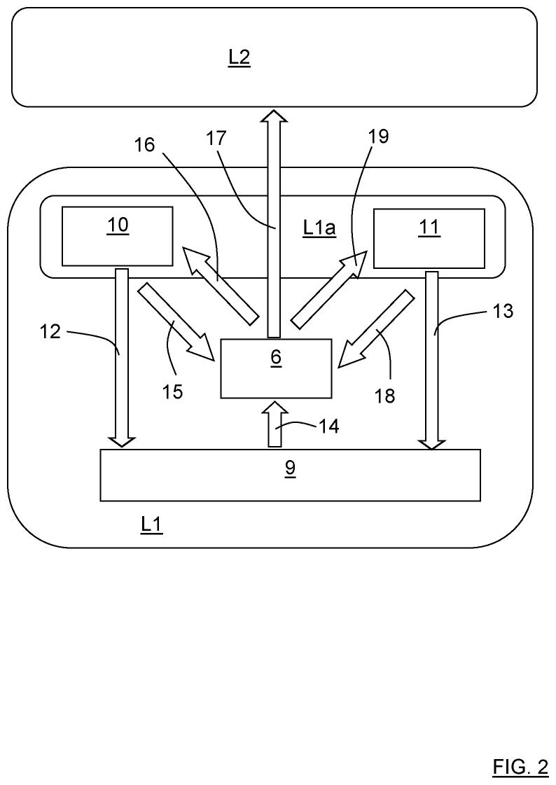

This is schematically illustrated in a block chart in FIG. 2, where, according to some aspects, there is a baseband layer L1 and at least one higher layer L2 that form example be constituted by the RRC 5. The baseband layer L1 comprises a resource scheduler 9 which is responsible for making scheduling decisions and allocates the radio resources over the air interface for both DL and UL. The baseband layer L1 comprises a dedicated layer L1a for UE context which keeps track of attached UE information. This layer can be further divided into DL UE context 10 and UL UE context 11 which keep track of downlink and uplink contexts respectively and are responsible for requesting radio resources from scheduler by sending a DL scheduling request 12 or UL scheduling request 13. UE means user equipment and is here equivalent to the user terminals 3a, 3b, 3c. The layer structure illustrated in FIG. 2 is only an example, many other types of layer structures are conceivable and are also well-known in the art.

According to the present disclosure, with reference to FIG. 1 and FIG. 2, the wireless communication system 1 comprises a control unit arrangement 6 that is adapted to acquire instructions relating to one or more certain predefined scheduling communication patterns for communication between the wireless communication node 2 and a served user terminal 3a, 3b, 3c comprised in a wireless communication system 1. The control unit arrangement 6 that is adapted to determine if the user terminal 3a, 3b, 3c is scheduled according to any one of the predefined scheduling communication patterns for a number of times that exceeds a predetermined number of times, and if that is the case, the control unit arrangement 6 is adapted to report the user terminal 3a, 3b, 3c to the communication traffic handling function 5 that is comprised in the wireless communication system 1. The user terminal is any one in a plurality of user terminals 3a, 3b, 3c, and the present disclosure is applicable for each user terminal in a plurality of user terminals 3a, 3b, 3c.

According to some aspects, the communication traffic handling function 5 is adapted to discontinue operation of the reported user terminal 3a, 3b, 3c when the predetermined number of times has been exceeded.

This means that the user terminal that displays a suspicious behavior in regard of a denial of service (DOS) attack can be disconnected from further operation in the communication system 1. The suspicious behavior is detected by means of signature-based detection where DoS attack patterns can be identified in advance and added to a dictionary. This dictionary of attack patterns can grow overtime, and the scheduling behaviors are compared with these stored signatures, and if there is a match, measures are taken.

The attack patterns correspond to predefined scheduling communication patterns, where, according to some aspects, a predefined scheduling communication pattern comprises that the number of re-transmissions in downlink (DL) from the node 2 to the user terminal 3a, 3b, 3c, has reached or falls below a predefined first maximum number of re-transmissions by a predefined number of times for a certain transmission. According to some further aspects, the predefined number of times is 1 or 2. For example, the number of re-transmissions is determined by means of a hybrid automatic repeat request (HARQ) response received from the user terminal 3a, 3b, 3c. For a DL data flow, the node 2 expects feedback in the form of a positive acknowledgement (ACK) or a negative acknowledgment (NACK) response from the user terminal 3a, 3b, 3c. If the user terminal 3a, 3b, 3c was able to successfully decode the DL data, it sends an ACK response. However, if the user terminal 3a, 3b, 3c was not able to decode the DL data it sends a NACK response instead.

This means that if an attacker gets access to the predefined maximum number of re-transmissions, the attacker can balance on the edge of the maximum number of re-transmissions and thus load the communication system 1 such that its capacity lowers. In particular, in the case of an attacker using a large number of user terminals that are automatically controlled, a so called botnet of user terminals, an attacker may be successful in performing a DOS attack on the DL radio resources.

In order to more accurately determine that a user terminal that displays a suspicious behavior in regard of a DOS attack, the predefined scheduling communication pattern can be a combination of features. According to some aspects, the predefined scheduling communication pattern comprises that a channel quality indication, such as a signal channel indicator (CQI), provided by the user terminal 3a, 3b, 3c, exceeds a certain CQI threshold value. This means that if the user terminal 3a, 3b, 3c seems to need all, all almost all, available re-transmissions time after time while the channel seem to be of good quality, the probability that the user terminal displays a suspicious behavior in regard of a DOS attack increases.

According to some aspects, for a downlink data handling scenario, the following information can be considered:
a. CQI value for scheduled user terminal channel quality
b. HARQ response received from the user terminal.
c. Number of retransmissions before successful ACK

If there is good CQI reported and if ACK:s are consistently received from user terminal 3a, 3b, 3c at, or near, max retransmission, the user terminal 3a, 3b, 3c is reported when this has happened a number of times that exceeds a predetermined number of times.

Correspondingly, for uplink (UL), according to some aspects, a predefined scheduling communication pattern comprises that the number of re-transmissions in UL from the user terminal 3a, 3b, 3c to the node 2, has reached or falls below a predefined second maximum number of re-transmissions by a predefined number of times for a certain transmission. According to some further aspects, the predefined number of times is 1 or 2. For example, the number of re-transmissions is determined by means of a hybrid automatic repeat request (HARQ) response decoded at the node 2. For an UL data flow, corresponding to the DL case, this results in an ACK or a NACK.

Additionally, discontinuous transmission (DTX) is possible if the user terminal 3a, 3b, 3c does not send anything at all in UL when it is supposed to send. The node 2 tries to decode, but since there is no signal sent from the user terminal 3a, 3b, 3c, the node 2 assumes that he signal was lost due to bad radio conditions and decodes it as a DTX.

In the same way as in the DL case, if an attacker gets access to the predefined maximum number of re-transmissions, the attacker can balance on the edge of the maximum number of re-transmissions and thus load the communication system 1 such that its capacity lowers. In particular, in the case of an attacker using a large number of user terminals that are automatically controlled, a so called botnet of user terminals, an attacker may be successful in performing a DoS attack on the UL radio resources.

In order to more accurately determine that a user terminal that displays a suspicious behavior in regard of a DOS attack, the predefined scheduling communication pattern can be a combination of features. According to some aspects, the predefined scheduling communication pattern comprises that a signal to interference plus noise ratio (SINR) value calculated for said certain transmission exceeds a certain SINR threshold value. According to some aspects, as an alternative or in combination with a SINR value, the predefined scheduling communication pattern comprises that for each re-transmission, there is a user terminal data buffer status report (BSR) from the user terminal 3a, 3b, 3c that exceeds a certain BSR threshold value. According to some aspects, the BSR indicates that the required network resources exceeds a predefined BSR threshold value, for example corresponding to a standard network resource measure. According to some aspects, such a BSR threshold value can be a BSR index exceeding 100, 150 or 200.

According to some aspects, for an uplink data handling scenario, the following information can be considered:
a. BSR report value for the user terminal.
b. HARQ response decoded in the node 2.
c. Number of retransmissions performed to successful ACK
d. SINR of the last successful uplink packet.

When the user terminal has reported BSR that is relatively high, possibly if the SINR also is relatively high, the number of retransmissions performed to achieve a successful ACK is considered. ACK:s are consistently received from user terminal 3a, 3b, 3c at, or near, max retransmission, the user terminal 3a, 3b, 3c is reported when this has happened a number of times that exceeds a predetermined number of times. According to some aspects, the communication traffic handling function 5 is adapted to discontinue operation of the reported user terminal 3a, 3b, 3c.

If the control unit arrangement 6 has determined that the served user terminal 3a, 3b, 3c is not scheduled according to any one of the predefined scheduling communication patterns, the control unit arrangement 6 is adapted to lower the number of times that the served user terminal 3a, 3b, 3c has been determined to be scheduled according to any one of the predefined scheduling communication patterns by a certain amount.

This means that if the user terminal 3a, 3b, 3c suddenly behaves normally, the number of times that the served user terminal 3a, 3b, 3c has been determined to behave in a suspicious manner is lowered, and according to some aspect, the number is lowered a certain amount that corresponds to the number being lowered to zero. Alternatively, the number is lowered a certain amount that differs from time to time that the control unit arrangement 6 is adapted to determine in a random manner.

According to some aspects, the discontinuation of operation is upheld for a certain time period. Alternatively the discontinuation of operation is according to some aspects permanent. According to some aspects, the discontinuation of operation is permanent if the operation of the user terminal 3a, 3b, 3c previously has been discontinued during a certain time period for a predetermined number of times.

According to some aspects, the traffic handling function is the RRC 5 that is adapted to inform the core network 4 if the operation of a user terminal 3a, 3b, 3c has been discontinued.

According to some aspects, the node 2 comprises a node control unit 8 that in turn comprises the control unit arrangement 6. According to some aspects, the wireless communication system 1 comprises a system control unit 7, where the system control unit 7 comprises the control unit arrangement 6′. According to some further aspects, the control unit arrangement 6″ is a separate unit that is adapted to be connected to a node control unit 8. Combinations of the above are of course conceivable.

In the above, it has been mentioned that the communication traffic handling function is comprised in the RRC 5, but other alternatives are of course possible, According to some aspects, the communication traffic handling function is comprised in the core network 4.

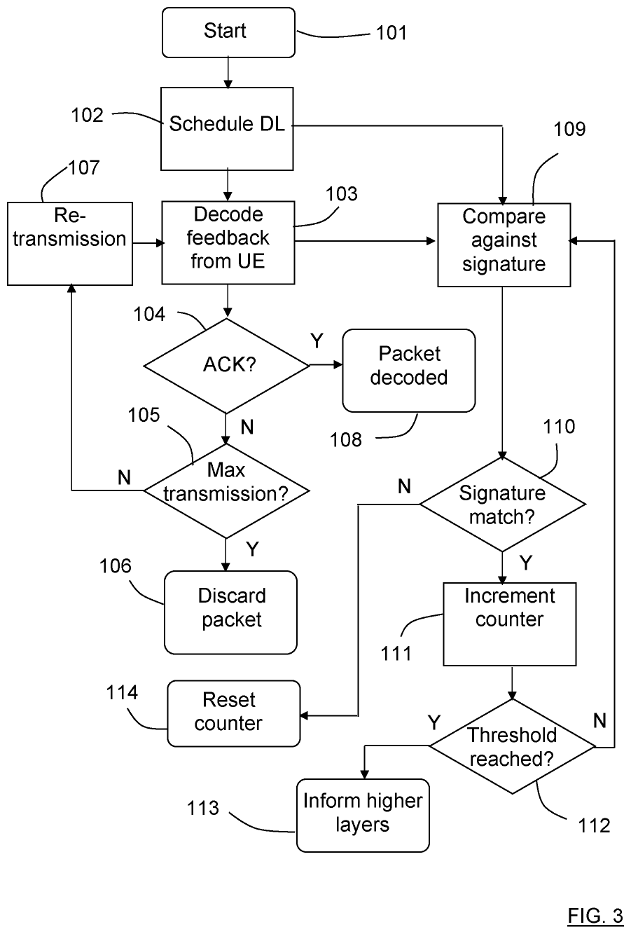

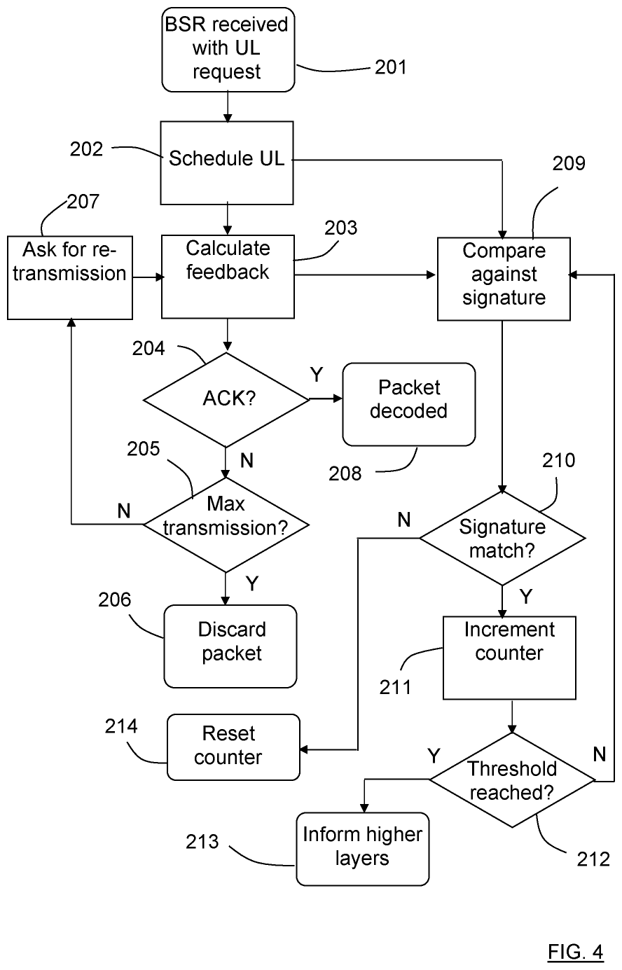

In the following, a more detailed example will be provided with particular reference to FIG. 2, FIG. 3 and FIG. 4.

In this example, the control unit arrangement 6 is comprised in a node control unit 8 in a baseband layer L1 and have access to the UE contexts 10, 11. It can be implemented as a separate process inside the base station 2 with the sole function of comparing attack patterns and informing the higher layers to act.

In a DL data scenario, the procedure is started 101 and the resource scheduler 9 will schedule 102 DL communication and forward key scheduling information 14 to the control unit arrangement 6 like slot number, SFN (System Frame Number), RNTI (Radio Network Temporary Identifier), number of PRBs (physical resource blocks) scheduled, transmission-attempts and CQI which will be saved in a memory at the control unit arrangement 6. The entity 10 which maintains the UE DL context in baseband will forward context information 15 to the control unit arrangement 6 like HARQ response, RNTI, slot number and SFN.

Feedback such as HARQ response from the user terminal 3a, 3b, 3c is decoded 103 and it is determined if the transmission of a packet results in an ACK 104, and if that is the case, the packet is decoded 108. If not, it is determined if the maximum number of transmissions has been reached 105. If that is the case, the packet is discarded 106, and if not, the packet is re-transmitted 107.

Meanwhile, the control unit arrangement 6 will match 109 the scheduling information, in the form of a signature, with the received HARQ response based on slot number, SFN and RNTI. If the transmission results in an ACK, and if the CQI is determined to be relatively good, but the transmission attempts have been either DTX or NACK until the last or almost last transmission attempt and then ACK, there is a signature match 110 and a pattern-counter for downlink is incremented 111. The counter is reset or lowered 114 in value if a break in the pattern is observed, i.e. if there is no signature match 110.

It is then determined if a threshold value has been reached 112, and if that is the case, the user terminal 3a, 3b, 3c has been scheduled according to a suspicious predefined scheduling communication pattern for a number of times that exceeds a predetermined number of times, and the user terminal 3a, 3,b,3c can be considered suspicious. The control unit arrangement 6 will then send 113 one or more alert reports 16, 17 to higher layers L1a, L2 such as the dedicated layer L1a for UE context, the core network 4 and/or the RRC 5.

For an UL data scenario, a BSR and UL request is received 201 from the user terminal 3a, 3b, 3c and the resource scheduler 9 will schedule 202 UL communication and forward key scheduling information 14 like slot number, SFN, RNTI, numbers of PRBs scheduled and transmissions-attempts to the control unit arrangement 6. The entity 11 which maintains the UE UL context will forward context information 18 to the control unit arrangement 6 like the HARQ response decoded, SINR, RNTI, slot number and SFN.

Feedback such as HARQ response is calculated 203 and it is determined if the transmission of a packet results in an ACK 204, and if that is the case, the packet is decoded 208. If not, it is determined if the maximum number of transmissions has been reached 205. If that is the case, the packet is discarded 206, and if not, the packet is re-transmitted 207.

Meanwhile, the control unit arrangement 6 will match 209 the scheduling information, in the form of a signature, with the decoded HARQ response based on received slot number, SFN and RNTI. If the transmission attempt is DTX until the last or almost last transmission attempt, and then ACK with good SINR, there is a signature match 210 and a pattern-counter for uplink is incremented 211. The counter is reset or lowered 214 in value if a break in the pattern is observed, i.e. if there is no signature match 210.

It is then determined if a threshold value has been reached 212, and if that is the case, the user terminal 3a, 3b, 3c has been scheduled according to a suspicious predefined scheduling communication pattern for a number of times that exceeds a predetermined number of times, and the user terminal 3a, 3,b, 3c can be considered suspicious. The control unit arrangement 6 will then send 213 one or more alert reports 16, 17 to higher layers as mentioned for DL.

The present disclosure is for example applicable for 5G that at present is an upcoming technology, and it is important to think about security early on. As the technology gets more widespread, so will the probability of being targeted by attackers. It is important to identify as many attack patterns and build a strong database to be better prepared to nullify them when the need arises. This database can grow stronger over time as more attack signatures are added to the list. This database can then be updated across all the base stations to be better prepared against similar attacks.

By making sure that the BSR and HARQ is not misused in a system, denial of service attacks can be prevented, which attacks otherwise can be difficult to detect and find defense against. Furthermore, the present disclosure can participate in achieving better system performance by removing the very bad performing real users from the system for short durations.

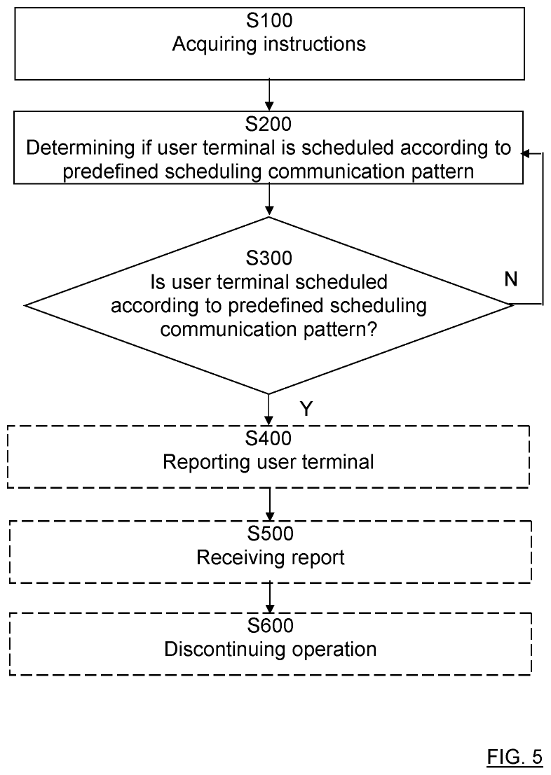

With reference to FIG. 5, the present disclosure also relates to a method in a wireless communication system 1. The method comprises acquiring S100 instructions relating to one or more certain predefined scheduling communication patterns for communication between a wireless communication node 2 and a served user terminal 3a, 3b, 3c in the wireless communication system 1, and determining S200 if the served user terminal 3a, 3b, 3c is scheduled according to any one of the predefined scheduling communication patterns for a number of times that exceeds a predetermined number of times. If that is the case S300, the method comprises reporting S400 the user terminal 2 to a communication traffic handling function 4, 5 in the wireless communication system 1.

According to some aspects, the method comprises receiving S500 the reports at the communication traffic handling function 4, 5, and discontinuing S600 operation of the reported user terminal 3a, 3b, 3c.

According to some aspects, the discontinuation of operation is upheld for a certain time period.

According to some aspects, the discontinuation of operation is permanent.

According to some aspects, the discontinuation of operation is permanent if the operation of the user terminal 3a, 3b, 3c previously has been discontinued during a certain time period for a predetermined number of times.

According to some aspects, a predefined scheduling communication pattern comprises that the number of re-transmissions in downlink, DL, from the node 2 to the user terminal 3a, 3b, 3c, has reached or falls below a predefined first maximum number of re-transmissions by a predefined number of times for a certain. According to some aspects, the predefined number of times is 1 or 2.

According to some aspects, the predefined scheduling communication pattern comprises that a channel quality indication, provided by the user terminal 3a, 3b, 3c, exceeds a certain threshold value.

According to some aspects, the number of re-transmissions is determined by means of a hybrid automatic repeat request (HARQ) response received from the user terminal 3a, 3b, 3c.

According to some aspects, a predefined scheduling communication pattern comprises that the number of re-transmissions in uplink (UL) from the user terminal 3a, 3b, 3c to the node 2, has reached or falls below a predefined second maximum number of re-transmissions by a predefined number of times for a certain transmission. According to some aspects, the predefined number of times is 1 or 2.

According to some aspects, the predefined scheduling communication pattern comprises that a signal to interference plus noise ratio (SINR) value calculated for said certain transmission exceeds a certain SINR threshold value.

According to some aspects, the predefined scheduling communication pattern comprises that for each re-transmission, there is a user terminal data buffer status report, BSR, from the user terminal 3a, 3b, 3c that exceeds a certain BSR threshold value. According to some aspects, the BSR indicates that the required network resources exceeds the BSR threshold value.

According to some aspects, the number of re-transmissions is determined by means of a hybrid automatic repeat request (HARQ) response decoded at the node 2.

According to some aspects, if it has been determined that the served user terminal 3a, 3b, 3c is not scheduled according to any one of the predefined scheduling communication patterns, the method comprises lowering the number of times that the served user terminal 3a, 3b, 3c has been determined to be scheduled according to any one of the predefined scheduling communication patterns by a certain amount.

According to some aspects, the method comprises lowering the number a certain amount that corresponds to the number being lowered to zero. Alternatively, according to some further aspects, the method comprises lowering the number a certain amount that differs from time to time that the control unit arrangement 6, 6′, 6″ is adapted to determine in a random manner.

The present disclosure is not limited to the above, but may vary freely within the scope of the appended claims. For example, the control unit arrangement is a device or piece of software which is adapted to analyze the wireless traffic and monitor for a potential attack and mitigate it. The control unit arrangement can be implemented in many ways and have many different positions, for example as illustrated in FIG. 1 and previously described.

The present disclosure is applicable for many different wireless communication technologies where DoS attacks are possible.

1. A control unit arrangement comprising processing circuitry, memory and transceiver circuitry collectively configured to perform operations comprising:
acquire instructions relating to one or more certain predefined scheduling communication patterns for communication between a wireless communication node and a served user terminal comprised in a wireless communication system, and to determine if the user terminal is scheduled according to any one of the predefined scheduling communication patterns for a number of times that exceeds a predetermined number of times, and if that is the case, comprising processing circuitry, memory and transceiver circuitry further configured to perform operations comprising:
reporting the user terminal to a communication traffic handling function comprised in the wireless communication system.

2. The control unit arrangement according to claim 1, wherein a predefined scheduling communication pattern comprises that the number of re-transmissions in downlink, DL, from the node to the user terminal, has reached or falls below a predefined first maximum number of re-transmissions by a predefined number of times for a certain transmission.

3. The control unit arrangement according to claim 2, wherein the predefined number of times is 1 or 2.

4. The control unit arrangement according to claim 2, wherein the predefined scheduling communication pattern comprises that a channel quality indication, provided by the user terminal, exceeds a certain threshold value.

5. The control unit arrangement according to claim 2, wherein the number of re-transmissions is determined by means of a hybrid automatic repeat request, HARQ, response received from the user terminal.

6. The control unit arrangement according to claim 2, wherein a predefined scheduling communication pattern comprises that the number of re-transmissions in uplink, UL, from the user terminal to the node, has reached or falls below a predefined second maximum number of re-transmissions by a predefined number of times for a certain transmission.

7. The control unit arrangement according to claim 6, wherein the predefined number of times is 1 or 2.

8. The control unit arrangement according to claim 6, wherein the predefined scheduling communication pattern comprises that a signal to interference plus noise ratio, SINR, value calculated for said certain transmission exceeds a certain SINR threshold value.

9. The control unit arrangement according to claim 6, wherein the predefined scheduling communication pattern comprises that for each re-transmission, there is a user terminal data buffer status report, BSR, from the user terminal that exceeds a certain BSR threshold value.

10-25. (canceled)

26. A method in a wireless communication system, comprising:
acquiring instructions relating to one or more certain predefined scheduling communication patterns for communication between a wireless communication node and a served user terminal in the wireless communication system, and
determining if the served user terminal is scheduled according to any one of the predefined scheduling communication patterns for a number of times that exceeds a predetermined number of times, and if that is the case, the method comprises:
reporting the user terminal to a communication traffic handling function in the wireless communication system.

27. The method according to claim 26, wherein the method comprises:
receiving the reports at the communication traffic handling function; and
discontinuing operation of the reported user terminal.

28. The method according to claim 27, wherein the discontinuation of operation is upheld for a certain time period.

29. The method according to claim 27, wherein the discontinuation of operation is permanent.

30. The method according to claim 27, wherein the discontinuation of operation is permanent if the operation of the user terminal previously has been discontinued during a certain time period for a predetermined number of times.

31. The method according to claim 26, wherein a predefined scheduling communication pattern comprises that the number of re-transmissions in downlink, DL, from the node to the user terminal, has reached or falls below a predefined first maximum number of re-transmissions by a predefined number of times for a certain transmission.

32. The method according to claim 31, wherein the predefined number of times is 1 or 2.

33. The method according to claim 31, wherein the predefined scheduling communication pattern comprises that a channel quality indication, provided by the user terminal, exceeds a certain threshold value.

34-43. (canceled)
